(19) United States
(12) Patent Application Publication
(10) Pub. No.: US 2012/0203932 A1
(43) Pub. Date: Aug. 9, 2012

(54) MULTI-MASTER MEDIA METADATA SYNCHRONIZATION

(75) Inventors: Bruno K. da Costa, Redmond, WA (US); Shane McRoberts, Seattle, WA (US); Andrew L. Silverman, Redmond, WA (US); Zach Johnson, Woodinville, WA (US); Rodrigo Bomfim, Renton, WA (US); Rahul Verma, Sammamish, WA (US); Joseph McClanahan, Redmond, WA (US); Jeffrey C. Abraham, Seattle, WA (US); Sean Kollenkark, Seattle, WA (US)

(73) Assignee: MICROSOFT CORPORATION, Redmond, WA (US)

(21) Appl. No.: 13/023,404

(22) Filed: Feb. 8, 2011

(51) Int. Cl. G06F 15/16

(52) U.S. Cl. 709/248

(57) ABSTRACT

Various embodiments related to the ability to expose content for synchronization and consumption across all endpoint computing devices in a computing system are disclosed. For example, one disclosed embodiment provides a method for communicating between authenticated clients of a cloud-based computing system, including sending a read request for metadata of each of a plurality of endpoint computing devices and content stored on each of the plurality of endpoint computing devices that is aggregated in a data store, receiving the requested metadata. The method further includes performing a content consumption operation that changes a state of the requested metadata. The method further includes sending updated metadata generated based on the content consumption operation to synchronize aggregated metadata in the data store, and deleting local metadata.

### BACKGROUND

End users often have media collections that are spread across multiple endpoint computing devices (e.g., phones, personal computers, laptops, gaming consoles, tablet devices, etc.) spanning multiple networks. With the advent of fast network connections to most devices, and the ability to maintain almost continuous connectivity for many endpoints, users need not have a local copy of a piece of content in order to consume it. However, presently there is no way to know the location of all content in a user's collection from any of the user's endpoint computing devices in the user's domain. Moreover, presently there is no way to enable different computing devices operating on different platforms and having different capabilities to access and synchronize with a user's entire media collection for consumption from any endpoint in the user's domain.

### SUMMARY

Various embodiments related to the ability to expose content and associated metadata for synchronization and consumption across all endpoint computing devices in a computing system are disclosed. For example, one disclosed embodiment provides a method for communicating between authenticated clients of a cloud-based computing system, including sending a read request for metadata of each of a plurality of endpoint computing devices and content stored on each of the plurality of endpoint computing devices that is aggregated in a data store. The method further includes receiving the requested metadata. The method further includes performing a content consumption operation that changes a state of the requested metadata. The method further includes sending updated metadata generated based on the content consumption operation to synchronize aggregated metadata in the data store, and deleting local metadata.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an embodiment of a computing system of the present disclosure.

FIG. 2 is a flow diagram of an embodiment of a method for communicating between clients to synchronize metadata without use of local data storage.

FIG. 3 is a flow diagram of an embodiment of a method for communicating between clients to query for and filter specific metadata without use of local data storage.

FIG. 4 is a flow diagram of an embodiment of a method for communicating between clients to synchronize local metadata and aggregated metadata.

### DETAILED DESCRIPTION

The present description is related to the ability to expose media content across multiple endpoint computing devices in a user's domain or computing system, so that the content can be accessed and consumed from any of the multiple endpoint computing device in the user's domain or computing system. More particularly, the present description is related to accessing and synchronizing aggregated endpoint metadata for each endpoint computing device and content metadata for content stored on each endpoint computing device. For example, metadata may be aggregated into a cloud-based data store and across any number of clients that may be executed on disparate platforms. By aggregating metadata about each endpoint computing device and content stored on each endpoint computing device so that it is accessible from any client or endpoint computing device in the computing system, a client can modify metadata and/or consume content in an online or offline fashion and any metadata modified by such actions may be synchronized across the computing cloud and the endpoint computing devices of the computing system.

Furthermore, the aggregated metadata may be accessible through a cloud module or service that exposes application programming interfaces (APIs) and schemas that clients adhere to in order to communicate with the computing cloud and/or other clients, in order to access, modify, and/or synchronize metadata across the endpoint computing devices of the user's domain. In particular, the APIs may use a set of schemas that organize metadata into self-contained entities that can be synchronized independently across the computing system. Each schema may define a metadata entity as a different synchronization type. In some cases, a synchronization type may contain references to other synchronization types. For example, in a music setting, for given track, album and artist synchronization types, a track metadata entity includes references to an album metadata entity and an artist metadata entity. As another example, an album metadata entity includes a reference to an artist metadata entity.

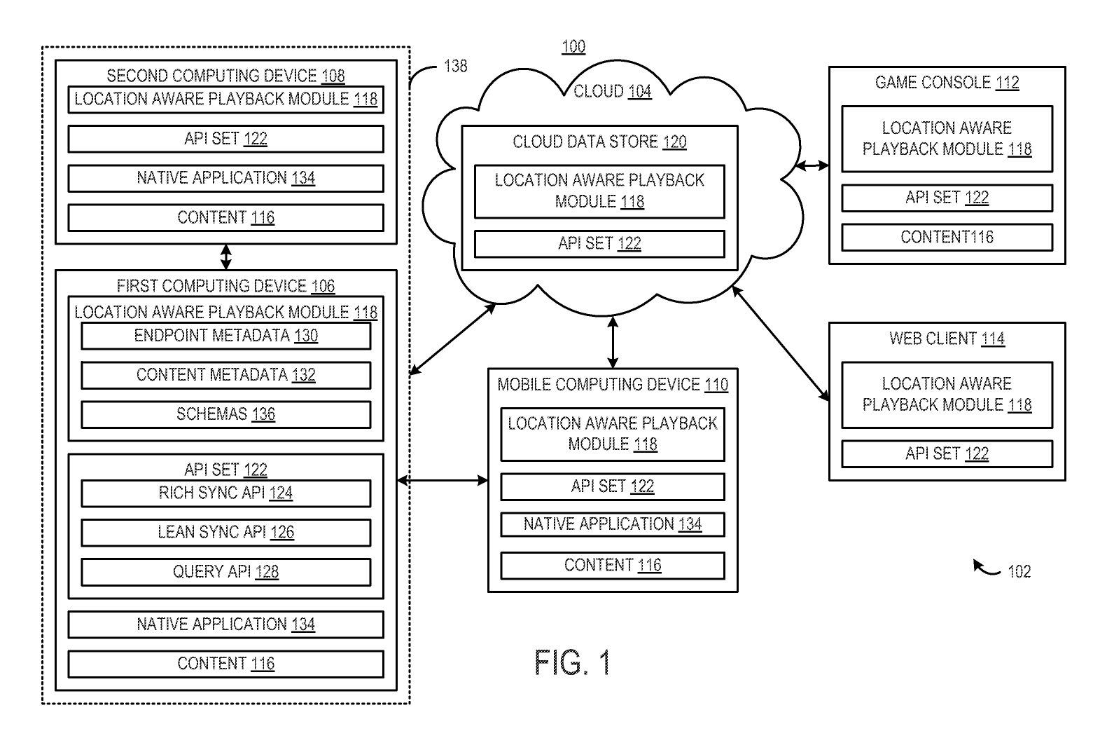

FIG. 1 shows a block diagram of an embodiment of a computing system 100 of the present disclosure. The computing system 100 may include a plurality of endpoint computing devices 102 that may be operatively coupled or in communication via a computing cloud 104. The computing cloud 104 may include various interconnected networks whereby shared computing devices (e.g., servers) can provide, pass, or share resources, software, and/or data to any, some, or all of the plurality of endpoint computing devices 102 and/or other devices as desired.

In the illustrated embodiment, the plurality of endpoint computing devices 102 may represent various computing devices in a user's domain or computing system. In other words, the plurality of endpoint computing devices may be accessed, used, controlled, and/or owned by the user. Such endpoint computing devices may be located in different locations, such as the user's home, school, office, car, person, etc. Moreover, such computing devices may be used for different applications, such as entertainment, education, occupation, communication, travel, etc. For example, the plurality of endpoint computing devices 102 may include a first computing device 106 (e.g., a personal computer), a second computing device 108 (e.g., a laptop computer), a mobile computing device 110 (e.g., a smart phone), and a game console 112. Additionally, the plurality of endpoint computing devices 102 may include a web client 114 that may be employed by the user to access the user's domain from another suitable computing device. For example, the web client 114 may be employed by the user to access the user's media collection from a public computer, such as at a library. As another example, the web client 114 may be employed by the user to access the user's media collection from a friend's computer. In some implementations, an endpoint of the user's domain may include a virtual marketplace, library, website, or other store hosted by a third party from which a user may retrieve or receive a license for a content item for consumption. Note in some implementations, the computing cloud 104 including the cloud data storage 120 may be classified as an endpoint of the user's domain.

In addition to being operatively coupled through the computing cloud 104, some endpoint computing devices may be directly connected without communicating through the computing cloud, which in some cases may be referred to as communicating “offline”. For example, the first computing device 106 and the second computing device 108 may communicate through a local area network 138 without connecting to the computing cloud. As another example, the mobile computing device 110 may directly connect to the first computing device 106, such as though a universal serial bus (USB) cable. Such connections, in some cases, may enable various synchronization, streaming, and/or playback operations to be carried out without communication through the computing cloud.

Some of the plurality of endpoint computing devices 102 may include or be configured to execute a native application 134 that uses the resources of an endpoint computing device to perform various synchronization, streaming, and/or playback operations. In some implementations, the native application 134 may be executed on a fully capable endpoint computing device such as the first computing device 106, which may have persistent connection to the computing cloud 104, holds content 116 (e.g., suitable data storage), and may have processing capability to carry out content item synchronization and management operations.

The plurality of endpoint computing devices 102 collectively stores a user's media collection, which may include different content items 116. As an example, content items 116 may include any suitable digital media, such as an image file, video file, audio file, or the like. In some cases, one or more content items 116 of the media collection may be stored in multiple locations. For example, a song may be stored on a user's personal computer as well as the user's smart phone. In some cases, more than one instance of a content item 116 may exist in the media collection. For example, an access restricted (e.g., digital rights management (DRM) restricted) instance of a song as well as a restriction-free instance of the song may be stored on a user's personal computer (or another endpoint computing device).

As discussed above, in order to expose a user's media collection to each endpoint computing device in the computing system 100, metadata may be aggregated for each endpoint computing device and each content item stored on each computing device. In particular, each computing device may be configured to execute a location aware playback module 118. The location aware playback module 118 may be configured to enable metadata synchronization of the plurality of endpoint computing devices 102 so that each endpoint is aware of each instance of each content item for playback. In particular, each endpoint computing device may be made aware of the storage location of every instance of every content item 116 in the user's media collection, as well as characteristics of each endpoint computing device and each instance of each content item via endpoint metadata 130 and content metadata 132. The endpoint metadata 130 and the content metadata 132 may be taken into consideration when retrieving an instance of a content item for playback on a selected endpoint computing device to provide a most suitable playback experience. For example, endpoint metadata 130 may include endpoint computing device capability, online status, connectivity speed/rate, network location, battery life, display capabilities, and streaming capabilities. Further, content metadata 132 may include access restrictions, encoding bit rate, format including resolution, audio streams (e.g., 2 channel, 5.1, 7.1, etc.), languages, subtitles, and playback state. Note although not shown in FIG. 1, each instance of the location aware playback module 118 may include elements listed in the elaborated example implemented on the first computing device 106, including endpoint metadata 130 and content metadata 132.

In some implementations, the process for communication and/or synchronization of metadata between the plurality of computing devices 102 may be cloud-based. For example, each endpoint computing device may send endpoint metadata 130 about that endpoint computing device, as well as content metadata 132 about each instance of each content item stored on that endpoint computing device to the computing cloud 104. Endpoint metadata 130 and content metadata 132 aggregated from the plurality of endpoint computing devices 102 may be held or stored in cloud data store 120. The cloud data store 120 may be synchronized or made available to each of the plurality of endpoint computing devices 102. In some cases, an endpoint computing device may send metadata to the cloud data store 120 responsive to the metadata being updated. In some cases, endpoint computing devices with intermittent cloud connectivity/connection persistence, such as a mobile computing device, may send metadata to the cloud data store 120 responsive to connection to the computing cloud 104.

Additionally or alternatively, in some implementations, the process for communication and/or synchronization of metadata between the plurality of computing devices 102 may be peer-to-peer (P2P) based. For example, each endpoint computing device may include a data store including endpoint metadata 130 and content metadata 132 aggregated from all of the user's endpoint computing devices in the computing system 100. Note the herein described aggregation operations are exemplary and other aggregation operations may be performed without departing from the scope of this description.

Once different instances of the content items and their storage locations have been exposed to each of the endpoint computing devices through the aggregation of endpoint and content metadata, the location aware playback module 118 may facilitate communication between clients for access, retrieval, and synchronization of metadata as well as retrieval of content for user consumption from any of the endpoint computing devices in the user's domain. In other words, the location aware playback module 118 may act as a client that may be executed by each of the endpoint computing devices (or the computing cloud 104) in the computing system 100 in order to communicate with other clients (e.g., other endpoint computing devices) directly or through the computing cloud 104. In particular, the location aware playback module 118 may be configured to enable communication between clients executed on different platforms and having varying degrees of capabilities through various APIs selected from a set of APIs 122. Each of the APIs in the set APIs 122 are tailored to enable specific types or classes of clients to access the aggregated endpoint metadata 130 and content metadata 132 for synchronization, modification, and/or retrieval of content for consumption.

The set of APIs 122 includes a rich synchronization API 124, a lean synchronization API 126, and a query API 128. The rich synchronization API 124 may be employed by a so-called rich client, such as a client that has local persistent storage capabilities. A rich client may have access to a greater amount of metadata and information locally relative to a so-called lean client. For example, a rich client may store endpoint metadata 130 and content metadata 132, and thus in order to update locally stored aggregated metadata with aggregated metadata from a different client (e.g., the computing cloud or another endpoint computing device), the rich synchronization API 124 may be configured to merely exchange metadata or information that is not known or outdated locally to synchronize the metadata. The rich synchronization API 124 may employ various protocols. For example, communications may be performed using hypertext transfer protocol (HTTP) requests with ATOM feed payloads as the wire protocol.

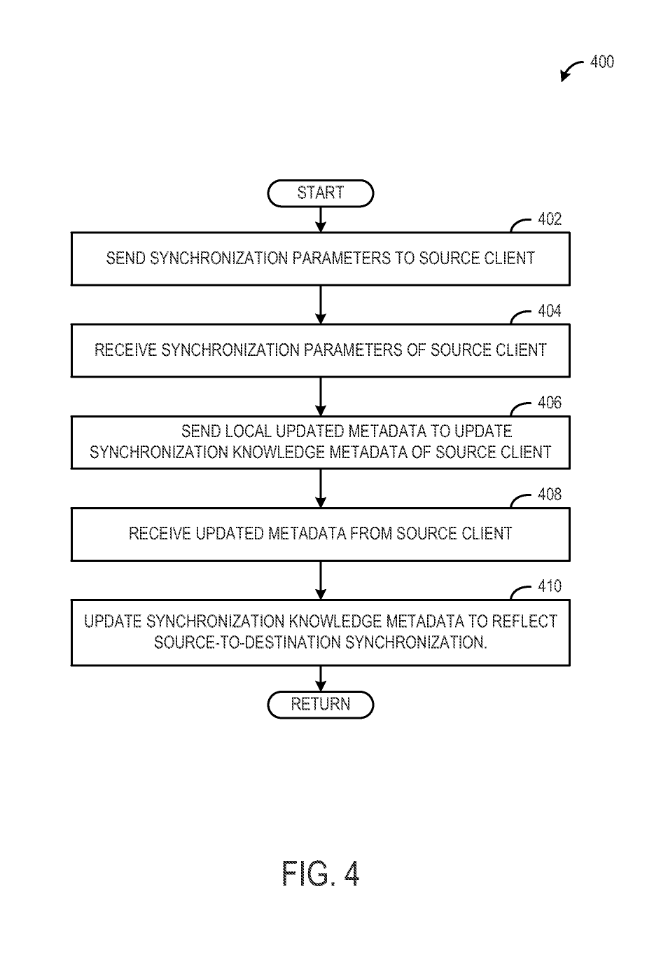

During the synchronization process using this API, clients may each take turns as the source and destination for exchanging unknown or updated metadata to complete synchronization at both ends. As one example, the location aware playback module 118, executed by the first computing device 106, uses the rich synchronization API 124 to exchange metadata directly with the second computing device 108 over the local area network 138 to synchronize metadata between the two endpoint computing devices. As another example, the location aware playback module 118, executed by the first computing device 106, uses the rich synchronization API 124 to exchange metadata with the cloud data store 120 via the computing cloud 104 to synchronize metadata between the first computing device and the cloud data store. The rich client synchronization API and associated methods are discussed in further detail below with reference to FIG. 4.

In contrast to a rich client, a lean client may not have persistent storage or the ability to run synchronization instructions locally, and thus in order to access and modify aggregated metadata, the lean synchronization API 126 may be configured such that large portions or an entirety of the aggregated metadata are passed to the lean client from the computing cloud 104 (or another client) to inform the lean client of the state of the metadata. In some cases, the received metadata may be temporarily stored or cached. Subsequently, the lean client may perform modifications to some metadata. Metadata may be modified through various actions of the user/client. For example, the user may modify metadata directly via user input. As another example, the user may consume content which may change the state of metadata associated with the content (e.g., makes content a “favorite”, increases a play count, etc.). The modified metadata may be sent to the computing cloud (or another client) via lean synchronization API 126, and/or the metadata may be deleted.

The lean synchronization API 126 may provide a representational state transfer service that uses create, read, update, and/or delete (CRUD) principles. The lean synchronization API 126 may employ various protocols. For example, each of the CRUD operations may be mapped to specific hypertext transfer protocol (HTTP) verbs. Further, ATOM feeds may be used as payloads in the communications. The lean synchronization API 126 exposes basic operations that are performed against metadata items in the cloud store and can be later detected by clients that use the rich synchronization API 124 for system-wide metadata synchronization.

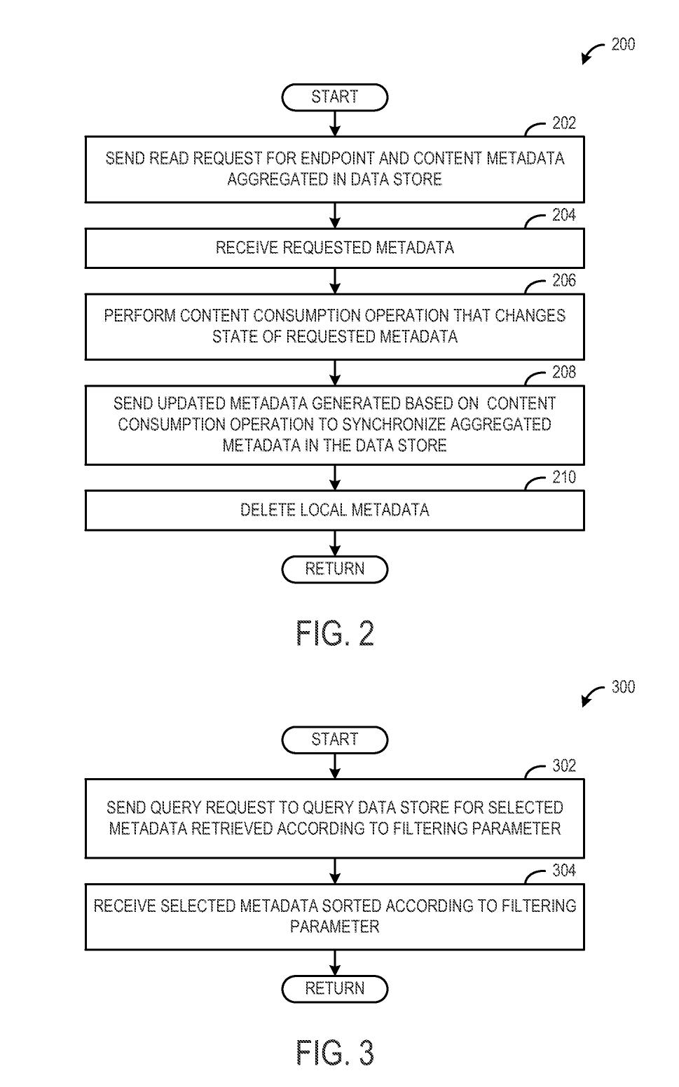

In some implementations, the lean synchronization API 126 may be employed for other lighter weight operations, such as streaming playback of a content item. The lean synchronization API 126 is a suitable vehicle for lower capability endpoint computing devices to carry out various operations; however it should be appreciated that lean synchronization API 126 may be employed by any of the plurality of endpoint computing devices 102. For example, the lean synchronization API 126 may be used in guest user scenarios, where a user does not desire a rich client experience or the like. As another example, the game console 112, which may have limited storage capacity, uses the lean synchronization API 126 to receive metadata from the cloud data store 120 via the computing cloud 104, modify the metadata, and subsequently send the updated metadata to the cloud data store 120 for system-wide synchronization. The lean client synchronization API and associated methods are discussed in further detail below with reference to FIG. 2.

The query API 128 provides a structured query of the aggregated metadata that may be employed by lean clients or clients without a local data store of aggregated metadata. The query API 128 may enable a client to provide one or more filtering parameters or search query parameters that may be used to filter or retrieve selected metadata entities from the aggregated metadata. The query API 128 allows for filtering and sorting of metadata present in the cloud data store 120, allowing storage-less or storage-limited clients to be provided with a rich view of targeted or selected metadata based on the filtering parameter. Note, the lean client may not store the information retrieved from the query (but may optionally as a caching mechanism), and may only retrieve metadata or other information for presentation to the user, rather than metadata about the entire collection. For example, a batch size may be specified as a filtering parameter and metadata may be retrieved according to the batch size. The query API and associated methods are discussed in further detail below with reference to FIG. 3.

The above described APIs use a set of schemas 136 that represent self-contained metadata entities of metadata elements that can be synchronized independently across endpoints of the computing system 100. These metadata entities (e.g. content metadata entities) may be classified or organized according to different synchronization types. Example schemas that define different synchronization types may include person, genre, album, track, favorite, video, podcast, picture, playlist, and playlist item schemas.

Furthermore, some synchronization types may include references to other synchronization types. In other words, some schemas may include a reference to a metadata entity of another synchronization type. For example, given track, album and artist synchronization types, a track may contain references to an album and an artist. As another example, the album may contain references to an artist. In some implementations, when a metadata entity that includes references to another metadata entity of a different synchronization type is sent, the referenced metadata entity may also be sent. In such implementations, a client may choose to wait for all related metadata to be sent/available before it decides to present that metadata to the user for modification, consumption, etc.

The following tables summarize one embodiment of the above discussed schemas 136 and list element names and element types included in the schemas.

TABLE 1
ALBUM schema
ALBUM

| Element Name | Element Type |
|---|---|
| ID | globallyUniqueID |
| title | String |
| releaseDate | dateTime |
| dateAquired | dateTime |
| isVisible | Boolean |
| contentRating | String |
| toc | String |
| serviceMediaID | globallyUniqueID |
| artistID | globallyUniqueID |

TABLE 2
GENRE schema
GENRE

| Element Name | Element Type |
|---|---|
| ID | globallyUniqueID |
| title | String |

TABLE 3
PERSON schema
PERSON

| Element Name | Element Type |
|---|---|
| ID | globallyUniqueID |
| Name | String |
| type | personType |
| | “artist” |
| | “composer” |
| | “conductor” |
| | “actor” |
| | “director” |
| isVisible | Boolean |
| serviceMediaID | globallyUniqueID |

TABLE 4
FAVORITE schema
FAVORITE

| Element Name | Element Type |
|---|---|
| ID | globallyUniqueID |
| type | String |
| position | Integer |
| itemType | favoriteItemType |
| | “person” |
| | “album” |
| | “track” |
| itemID | globallyUniqueID |
| serviceMediaID | globallyUniqueID |

TABLE 5
PLAYLIST schema
PLAYLIST

| Element Name | Element Type |
|---|---|
| ID | globallyUniqueID |
| title | String |
| author | String |
| type | playlistType |
| | “static” |
| | “auto” |
| | “channel” |
| | “smartDJ” |
| | “flag” |
| dateAcquired | dateTime |
| serviceMediaID | globallyUniqueID |

TABLE 6
PLAYLIST ITEM schema
PLAYLIST ITEM

| Element Name | Element Type |
|---|---|
| ID | globallyUniqueID |
| playlistID | globallyUniqueID |
| position | Integer |
| itemType | playlistItemType |
| itemID | globallyUniqueID |
| itemServiceMediaID | globallyUniqueID |

TABLE 7
TRACK schema
TRACK

| Element Name | Element Type |
|---|---|
| ID | globallyUniqueID |
| title | String |
| trackNumber | Integer |
| discNumber | Integer |
| length | Duration |
| releaseDate | dateTime |
| dateAquired | dateTime |
| isVisible | Boolean |
| copyright | String |
| contentRating | String |
| serviceMediaID | globallyUniqueID |
| albumID | globallyUniqueID |
| artistID | globallyUniqueID |
| genreID | globallyUniqueID |
| composerID | globallyUniqueID |
| conductorID | globallyUniqueID |

Continuing with FIG. 1, in different implementations, endpoint computing devices may take the form of a mainframe computer, server computer, desktop computer, laptop computer, tablet computer, home entertainment computer, network computing device, mobile computing device, mobile communication device, gaming device, etc.

Furthermore, each endpoint computing device may include a processing device and a data storage device. The processing device includes one or more physical devices configured to execute one or more instructions. For example, the processing device may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The data storage device may include one or more physical, non-transitory, devices configured to hold data and/or instructions executable by the logic subsystem to implement the herein described methods and processes. When such methods and processes are implemented, the state of the data storage device may be transformed (e.g., to hold different data). The data storage device may include removable computer-readable storage media and/or built-in devices. The data storage device may include optical memory devices (e.g., CD, DVD, HD-DVD, Blu-Ray Disc, etc.), semiconductor memory devices (e.g., RAM, EPROM, EEPROM, Flash memory, etc.) and/or magnetic memory devices (e.g., hard disk drive, floppy disk drive, tape drive, MRAIVI, etc.), among others. The data storage device may include devices with one or more of the following characteristics: volatile, nonvolatile, dynamic, static, read/write, read-only, random access, sequential access, location addressable, file addressable, and content addressable data storage.

The terms “module,” “program,” “service,” and “engine” may be used to describe an aspect of computing system 100 that is implemented to perform one or more particular functions. In some cases, such a module, program, service, or engine may be instantiated via the processing device executing instructions held by the data storage device. It is to be understood that different modules, programs, and/or engines may be instantiated from the same application, service, code block, object, library, routine, API, function, etc. Likewise, the same module, program, service, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc. It is to be appreciated that a “service”, as used herein, may be an application program executable across multiple user sessions and available to one or more system components, programs, and/or other services. In some implementations, a service may run on a server responsive to a request from a client.

FIG. 2 is a flow diagram of an embodiment of a method 200 for communicating between clients to synchronize metadata without use of local data storage. At 202, the method may include sending a read request for metadata of each of a plurality of endpoint computing devices and content stored on each of the plurality of endpoint computing devices that is aggregated in a data store. As one example, referring to FIG. 1, the web client 114 may send the read request to the computing cloud 104 to read endpoint metadata 130 and content metadata 132 stored in the cloud data store 120.

At 204, the method may include receiving the requested metadata. Continuing with the above example, the web client 114 may receive the requested endpoint metadata 130 and content metadata 132 from the cloud data store 120.

At 206, the method may include performing a content consumption operation that changes a state of the requested metadata. Various content consumption operations may be performed that change the state of the requested metadata. For example, a content consumption operation may include consuming a content item (e.g., playing a song), which may result in modification of metadata associated with the content item, such as increasing a play count of the content item. As another example, a content consumption operation may include directly modifying metadata via user input. In one particular example, a user directly changes metadata associated with an audio file by providing input to change the title of the file.

At 208, the method may include sending updated metadata generated based on the content consumption operation to synchronize aggregated metadata in the data store. Continuing with the above example, the web client 114 may send metadata updated during or as a result of the content consumption operation to the computing cloud 104 to update metadata aggregated in the cloud data store 120.

At 210, the method may include deleting local metadata. In some implementations, a client may have limited or no data persistent date storage, and received metadata may be temporarily stored or cached. Subsequent to modifications to the received metadata the local metadata may be deleted to free up local resources for other operations.

The method described above enables a user to access and/or modify aggregated metadata from any client including endpoints computing devices with restricted data storage capabilities (e.g., lean clients). Moreover, the method enables modified or updated metadata to be automatically synchronized with the aggregated metadata and correspondingly each of the endpoint computing devices in the user's domain.

Note the above described method may be implemented as an API. In particular, sending the read request, receiving the requested metadata, sending the updated metadata, and deleting the local metadata may be performed via an API. In one particular example, the lean synchronization API 126 of FIG. 1 includes the above described method.

FIG. 3 is a flow diagram of an embodiment of a method 300 for communicating between clients to query for and filter specific metadata without use of local data storage. At 302, the method may include sending a query request to query a data store for selected metadata retrieved according to a filtering parameter. The data store may hold aggregated endpoint metadata and content metadata for all endpoint computing devices in a user's domain. Such an aggregation may produce a significant amount of metadata that may be difficult to maneuver through when searching for specific metadata. The query request enables a user to target specific metadata for access or modification.

The filtering parameter may include any suitable item within a metadata entity, such as one or more items of the synchronization type schemas discussed above. Moreover, a filtering parameter may include any suitable parameter by which retrieved metadata may be sorted or listed. Furthermore, the filtering parameter may include a batch size.

At 304, the method may include receiving the selected metadata sorted according to the filtering parameter. The selected metadata may be sorted according to the filtering parameter so that a user may easily search the selected metadata for desired information. In cases where a batch size is specified, metadata may be received in batches according to the specified batch size so that the client/endpoint doesn't have to download the full query result, if desired. In other words, even with filtering, the metadata returned may be still too large, and the batch size allows the resulting metadata to be returned in batches so that it can be manageably consumed at the client/endpoint.

The method described above provides a structured query for clients without a local store that filters and sorts selected data stored in the cloud store. The method enables storage-less or storage-limited client to be provided with a rich view of the metadata. Note the above described method may be implemented as an API. In particular, sending the query request and receiving the selected metadata may be performed via an API. In one particular example, the query API 128 of FIG. 1 is configured to implement the above described method.

FIG. 4 is a flow diagram of an embodiment of a method 400 for communicating between clients to synchronize local metadata and aggregated metadata. In the method, each client acts as a source and a destination (to enable two-way metadata synchronization. At 402, the method may include sending synchronization parameters to a source client. The synchronization parameters may include a change batch size defining how many metadata changes can be performed per batch and synchronization knowledge metadata indicating a local metadata state. The metadata state may include changes or metadata entities that are stored locally or changes or metadata that the client knows about. The synchronization parameters may be sent to another client.

As one example, referring to FIG. 1, the first computing device may send the synchronization parameters to the computing cloud 104. The location aware playback module 118 executed by the computing cloud 104 uses the synchronization knowledge received from the first computing device 106 to determine what metadata that is stored in the cloud data store 120 that has been added, changed, or deleted more recently than the metadata stored locally on the first computing device 106. The location playback aware module 118 sends one or more change batches of up to the specified change batch size of updated metadata to the first computing device 106. In some implementations, change batches may be communicated via a HTTP POST where the post request body contains the destination's preferred batch size and sync knowledge. The post response body may contain not only the change batch itself, but also the actual metadata associated with the items in the batch. Such communication organization may conserve bandwidth and avoid a subsequent metadata retrieval roundtrip.

At 404, the method may include receiving synchronization parameters for the source client. The synchronization parameter may include a change batch size and synchronization knowledge metadata of the source client. Continuing with the above example, the first computing device 106 may receive synchronization parameters from the computing cloud 104. In some implementations, the first computing device 106 retrieves the cloud service synchronization parameters via an HTTP GET request, and sends change batches to the computing cloud 104 via an HTTP PUT request. As before, the PUT request may contain not only the change batch items, but also the actual metadata that the computing cloud needs to store for metadata synchronization. Moreover, in some implementations, ATOM feeds may be used as payload in the HTTP messages. ATOM feeds contain a list of entries and each entry contains metadata and content. The schema for content may vary according to the different schemas described above for each supported synchronization type (e.g.: genre, artist, album, track, etc).

At 406, the method may include sending local updated metadata to update synchronization knowledge metadata of the source client to reflect destination-to-source synchronization. The metadata may be sent in increments according to the change batch size specified by the source client. The local updated metadata may include local metadata having a more recent state change relative to the metadata state of the source client. For example, a user may modify metadata locally offline, which may be sent to the computing cloud for metadata synchronization.

At 408, the method may include receiving updated metadata from the source client. The metadata may be received in increments according to the change batch size specified by the synchronization parameters of the destination client. The updated metadata may include metadata that has a more recent state change relative to the local metadata state. In other words, the updated metadata may be newly added metadata or metadata that has been edited, or deleted more recently than the instance stored locally at the client. Continuing with the above example, the first computing device 106 may receive updated metadata from the computing cloud 104. In some implementations, the destination client may check the instance of each of the metadata items in the source's change batch to verify that the metadata is actually a newer instance and whether the local instance needs to be brought up to date. Any instance conflicts may be detected and resolved at this stage.

At 410, the method may include updating the synchronization knowledge metadata of the destination client to reflect source-to-destination synchronization. Updating may include locally storing updated metadata received from the source client.

The method described above enables clients having local storage to determine what changes exist between aggregated metadata collections stored locally and in the computing cloud (or locally on another client) and facilitates transmission of such metadata in order to complete two-way synchronization. In this way, aggregated metadata may be synchronized between each of the endpoint computing devices in the user's domain.

Note the above described method may be implemented by an API. In particular, sending synchronization parameters, receiving updated metadata, and updating the synchronization knowledge metadata may be performed via an API. Furthermore, receiving synchronization parameters and sending local updated metadata may be performed via the API. In one particular example, the rich synchronization API 128 of FIG. 1 is configured to implement the above described method.

In some implementations, the above described methods may be implemented in combination. In some implementations, the methods may be performed via different APIs that may be used by a program, module, and/or service to access, modify, and/or synchronize metadata. In some implementations, a client may utilize more than one method/API or a combination of methods to communicate with other clients in the computing system.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for communicating between authenticated clients of a computing system, comprising:
sending a read request for metadata of each of a plurality of endpoint computing devices and content stored on each of the plurality of endpoint computing devices that is aggregated in a data store;
receiving the requested metadata;
performing a content consumption operation that changes a state of the requested metadata; and
sending updated metadata generated based on the content consumption operation to synchronize aggregated metadata in the data store.

2. The method of claim 1, wherein sending the read request, receiving the requested metadata, sending the updated metadata, and deleting the local metadata is performed via an application programming interface.

3. The method of claim 1, further comprising:
sending a query request to query the data store for selected metadata retrieved according to a filtering parameter; and
receiving the selected metadata sorted according to the filtering parameter.

4. The method of claim 3, wherein sending the query request and receiving the selected metadata is performed via an application programming interface.

5. The method of claim 1, further comprising:
sending synchronization parameters to a source client;
receiving synchronization parameters of the source client;
sending local updated metadata to update synchronization knowledge metadata of the source client to reflect destination-to-source synchronization, the local updated metadata including local metadata having a more recent state change relative to a metadata state of the source client;
receiving updated metadata from the source client, the updated metadata including metadata having a more recent state change relative to a local metadata state; and
updating the synchronization knowledge metadata to reflect source-to-destination synchronization.

6. The method of claim 5, wherein the synchronization parameters include a change batch size defining how many metadata changes can be performed per batch and synchronization knowledge metadata indicating a local metadata state.

7. The method of claim 5, wherein sending synchronization parameters, receiving updated metadata, and updating the synchronization knowledge metadata are performed via an application programming interface.

8. The method of claim 7, wherein the application programming interface is carried out according to a hypertext transfer protocol.

9. The method of claim 1, wherein the data store includes a cloud-based data store accessible by a plurality of endpoint computing devices in the computing system.

10. The method of claim 1, wherein the data store is included in each of the plurality of endpoint computing devices.

11. The method of claim 1, wherein the metadata for content is organized into synchronization types defined by schemas including person, genre, album, track, favorite, video, podcast, picture, playlist, and playlist item schemas.

12. The method of claim 11, wherein one or more of the schemas includes metadata that reference another synchronization type.

13. A system comprising:
a plurality of endpoint computing devices in communication via a computing cloud including a data store of aggregated metadata of each of the plurality of endpoint computing devices and content stored on each of the plurality of endpoint computing devices, one or more of the plurality of endpoint computing devices comprising:
an application programming interface configured to send a read request for metadata aggregated in the data store, receive the requested metadata, and send updated metadata, generated based on a content consumption operation that changes a state of the requested metadata locally, to synchronize aggregated metadata in the data store.

14. The system of claim 13, wherein one or more of the plurality of endpoint computing devices comprises:
an application programming interface configured to send a query request to query the data store for selected metadata retrieved according to a filtering parameter, and receive the selected metadata sorted according to the filtering parameter.

15. The system of claim 13, wherein one or more of the plurality of endpoint computing devices comprises:
an application programming interface configured to send synchronization parameters to a source client, receive synchronization parameters of the source client, send local updated metadata to update synchronization knowledge metadata of the source client to reflect destination-to-source synchronization, the local updated metadata including local metadata having a more recent state change relative to the metadata state of the source client, receive updated metadata from the source client, the updated metadata including metadata having a more recent state change relative to the local metadata state, and update the synchronization knowledge metadata to reflect source-to-destination synchronization.

16. The system of claim 13, wherein the synchronization parameters include a change batch size defining how many metadata changes can be performed per batch and synchronization knowledge metadata indicating a local metadata state.

17. The system of claim 13, wherein the metadata for content is organized into synchronization types defined by schemas including person, genre, album, track, favorite, video, podcast, picture, playlist, and playlist item schemas.

18. The system of claim 17, wherein one or more of the schemas includes metadata that references another synchronization type.

19. A system comprising:
a plurality of endpoint computing devices in communication via a computing cloud including a data store of aggregated metadata of each of the plurality of endpoint computing devices and content stored on each of the plurality of endpoint computing devices,
one or more of the plurality of endpoint computing devices comprising:
an application programming interface configured to send a read request for metadata aggregated in the data store, receive the requested metadata, send updated metadata, generated based on a content consumption operation that changes a state of the requested metadata locally, to synchronize aggregated metadata in the data store, and delete local metadata;
one or more of the plurality of endpoint computing devices comprises:
an application programming interface configured to send a query request to query the data store for selected metadata retrieved according to a filtering parameter, and receive the selected metadata sorted according to the filtering parameter; and
one or more of the plurality of endpoint computing devices comprises:
an application programming interface configured to send synchronization parameters including a change batch size defining how many metadata changes can be performed per batch and synchronization knowledge metadata indicating a local metadata state, receive updated metadata in increments according to the change batch size, the updated metadata including metadata having a more recent state change relative to the local metadata state, update the synchronization knowledge metadata to reflect source-to-destination synchronization, receive synchronization parameters including a change batch size and synchronization knowledge metadata of a source client, and send local updated metadata in increments according to the change batch size to update synchronization knowledge metadata of the source client to reflect destination-to-source synchronization, the local updated metadata including local metadata having a more recent state change relative to the metadata state of the source client.

20. The system of claim 19, wherein the metadata for content is organized into self-contained synchronization types defined by schemas including person, genre, album, track, favorite, video, podcast, picture, playlist, and playlist item schemas, and wherein one or more of the schemas includes a reference to metadata of another synchronization type, and sending metadata of the one or more schemas includes also sending referenced metadata of another synchronization type.
